(19) United States
(12) Patent Application Publication
(10) Pub. No.: US 2026/0272216 A1
(43) Pub. Date: Sep. 17, 2026

(54) COOKING MACHINE AND CONTROL METHOD

(71) Applicant: FLEXISPOT INC., Irvine, CA (US)

(72) Inventors: Yinshui XIA, Irvine, CA (US); Chuanfeng WANG, Irvine, CA (US); Ming XU, Irvine, CA (US); Guangying YANG, Guangxi (CN)

(21) Appl. No.: 19/564,809

(22) Filed: Mar. 12, 2026

(30) Foreign Application Priority Data
Mar. 17, 2025 (CN) 202510309885.1
Mar. 17, 2025 (CN) 202510309886.6
Mar. 17, 2025 (CN) 202520458182.0

(51) Int. Cl. A47J 36/00; B65B 69/00

(52) U.S. Cl. CPC A47J 36/00; B65B 69/00

(57) ABSTRACT

A cooking machine capable of automatically tearing a sealing film includes an shaft with a hook configured to engage with the sealing film of a food container and tear the sealing film during rotation. A method for unwinding a sealing film of a cooking machine controls the shaft to reversely rotate to unwind the sealing film after a cover of the cooking machine is opened, thereby inhibiting the sealing film from falling into a body of the cooking machine. A control method for the cooking machine adjusts, before the cooking machine starts, a position of the hook on the shaft so that the hook faces the sealing film, enabling the hook to engage with the sealing film and facilitating reliable tearing of the sealing film.

### CROSS-REFERENCE TO RELATED APPLICATIONS

This application claims priority to and the benefit of Chinese Patent Application No. 202510309886.6, filed on Mar. 17, 2025, Chinese Patent Application No. 202520458182.0, filed on Mar. 17, 2025, and Chinese Patent Application No. 202510309885.1, filed on Mar. 17, 2025, which are hereby incorporated by reference in their entirety.

### TECHNICAL FIELD

This application relates to the field of cooking equipment, specifically to a cooking machine and a cooking machine control method.

### BACKGROUND TECHNOLOGY

A cooking machine is a smart kitchen appliance that simplifies and streamlines the cooking process, making cooking more efficient and popular in households. Generally, the cooking machine includes a body and a cover covering the top of the body. The cover has a food inlet communicating with the body. In the related art, a food container is usually used to store the cooking materials, and it can be sealed with a sealing film attached to its opening. Therefore, the top of the cover can support and match the food container that is placed upside down, and the cover is connected to a film-tearing device. When the cooking machine is working, the food container is placed upside down on the cooking machine, and a film-tearing process will be performed. The film-tearing device tears the sealing film attached to the opening of the food container, allowing the cooking materials to fall into the body of the cooking machine as expected. The cooking machine then cooks the cooking materials according to the preset cooking program.

In the prior art, the film-tearing device of the cooking machine has the following defects in the actual film-tearing process. The hook is set at the edge of the groove on the shaft configured to tear the sealing film or inside the groove, and the hook does not protrude from the outer circumference of the shaft. When the food container is supported on the cover with its sealing film facing the cover, the free end of the hook just reaches the sealing film or is located below the sealing film. This requires the user to press the sealing film with their hand so that the opening on the sealing film can be hooked onto the hook. Therefore, the operation is relatively troublesome and laborious. Furthermore, because the winding space between the hook and the bottom of the hook is small, the wound sealing film is prone to sticking to the shaft, making it difficult to unwind and remove the sealing film and also causing inconvenience in cleaning. In addition, the shaft will generate heat during continuous operation, and some cooking machines require the user to remove the wound sealing film by hand, which may result in burns and poor safety. Some cooking machines rotate the shaft in another direction to unwind sealing film, but if the sealing film removal button is pressed to unwind the sealing film after cooking is finished and the cover is not opened, the sealing film may fall into the food inside the body. This is not only unhygienic, but also poses a risk of burns from the high-temperature steam inside the body when removing the sealing film. Furthermore, manually pressing the sealing film removal button to start this process is cumbersome and results in a poor user experience.

### SUMMARY

The present application provides a cooking machine, comprising:

a body, comprising a base and a heating device;

a cover mounted on the body, wherein the cover has an opening that extends through the cover, and the cover is configured to support a food container with a sealing film facing downwards; and

a shaft, comprising a shaft body and a hook, wherein the shaft is disposed inside the opening of the cover, and the hook is disposed on the shaft body; the hook comprises a shank and a transverse portion; the two ends of the shank are respectively connected to the shaft body and the transverse portion; a lower surface of the transverse portion is radially outward relative to a circumference of the shaft body, so that when the hook faces a top of the cover, the hook enters an interior of the food container through an opening on the sealing film of the food container and the lower surface of the transverse portion is higher than an edge of the opening of the sealing film.

In some embodiments, an angle between the shank and the lower surface of the transverse portion is less than or equal to 90 degrees.

In some embodiments, a top surface of the transverse portion is configured as a smoothly transitioned arc surface.

In some embodiments, the shaft body is tapered in shape, and an axis of the shaft body is arranged horizontally.

In some embodiments, the shaft body is provided with a mounting plane, and the hook is mounted on the mounting plane.

In some embodiments, the shaft is integrally formed.

In some embodiments, the hook is configured to move in a radial direction relative to the shaft body, and an elastic element is connected between the hook and the shaft body to make the hook have a tendency to move away from the shaft body.

In some embodiments, the cooking machine further includes:

a motor connected to the shaft, wherein the motor is configured to drive the shaft to rotate, so that the shaft winds and tears off the sealing film on the food container or unwinds the sealing film wound on the shaft;

an open state sensor assembly, wherein the open state sensor assembly is configured to detect a position of the cover, identify an open state of the cover, and send a first signal;

a control module, wherein the control module is configured to detect the first signal and to control the shaft to rotate after the first signal is detected.

In some embodiments, the open state sensor assembly comprises a trigger and a sensor; one of the trigger and the sensor is connected to the cover, and the other one of the trigger and the sensor is connected to the body of the cooking machine; the open state sensor assembly detects the position of the cover according to sensing information of the sensor, and when the trigger moves away from the sensor, the open state sensor assembly determines that the open state is open.

In some embodiments, the sensor is a magnetic reed switch, the trigger is a magnet; when the magnet moves away from the magnetic reed switch, the magnetic reed switch switches between on and off states to generate the first signal.

In some embodiments, the cover is pivotally connected to the body, and the magnetic reed switch and the magnet are both disposed at a side away from the pivot.

In some embodiments, the cooking machine further includes a rotation angle sensor assembly arranged for detecting a rotation angle of the shaft.

In some embodiments, the rotation angle sensor assembly comprises a second magnet connected to a motor shaft of the motor and a sensor assembly connected to the cover; the sensor assembly comprises a magnetic induction chip, the magnetic induction chip is configured to detect an angular position of the shaft by sensing a change of a magnetic field of the second magnet.

The present application provides a method for unwinding a sealing film of a cooking machine, comprising:

identifying an open state of a cover by an open state sensor assembly;

generating, in response to the open state being open, a first signal by the open state sensor assembly;

sending, in response to the first signal, a second signal by a control module; and

rotating, in response to the second signal, a shaft by a motor so as to unwind a sealing film wound around the shaft.

In some embodiments, the identifying, by an open state sensor assembly, an open state of a cover, comprises:

controlling, according to a distance between a magnet and a magnetic reed switch, a conduction state of a circuit by the magnetic reed switch;

determining, according to the conduction state of the circuit, the open state of the cover by the open state sensor assembly;

wherein one of the magnet and the magnetic reed switch is connected to the cover of the cooking machine, and the other one of the magnet and the magnetic reed switch is connected to a body of the cooking machine.

In some embodiments, the identifying, by an open state sensor assembly, an open state of a cover, comprises:

obtaining sensing information by a sensor; and

determining, according to the sensor information, the open state of the cover by the open state sensor assembly;

wherein the sensor is connected to the cover or a body of the cooking machine.

In some embodiments, the sending, in response to the first signal, a second signal by a control module, comprises:

sending after a delay, in response to the first signal, a second signal by a control module.

In some embodiments, the rotating, in response to the second signal, a shaft by a motor so as to unwind a sealing film wound around the shaft, comprises:

the motor starting to rotate the shaft;

in response to an absence the first signal, the control module sending a third signal;

in response to the third signal, the motor stopping rotating the shaft.

The present application provides a control method for a cooking machine, comprising:

detecting a rotation angle of a hook by a rotation angle sensor assembly;

generating, according to the rotation angle of the hook, adjustment information by a rotation angle sensor assembly;

rotating, according to the adjustment information, a shaft by a motor so as to adjust the hook to face a top of the cover;

rotating, in response to a start signal, the shaft by the motor to wind and tear off a sealing film of a food container.

Other features and advantages of the present application will become apparent from the following detailed description of exemplary embodiments of the present application with reference to the drawings.

### BRIEF DESCRIPTION OF DRAWINGS

FIG. 1 is a structural schematic diagram of a cooking machine according to some embodiments of the present application.

FIG. 2 is a structural schematic diagram of a film-tearing device for a cooking machine according to some embodiments of the present application.

FIG. 3 is a structural schematic diagram of a cover of a film-tearing device for a cooking machine according to some embodiments of the present application.

FIG. 4 is a structural schematic diagram of a shaft of a film-tearing device for a cooking machine according to some embodiments of the present application.

FIG. 5 is a cross-sectional structural schematic diagram of a film-tearing device for a cooking machine according to some embodiments of the present application.

FIG. 6 is a side view of the shaft of a film-tearing device for a cooking machine according to some embodiments of the present application.

FIG. 7 is a structural schematic diagram of a shaft according to some other embodiments of the present application.

FIG. 8 is a structural schematic diagram of a shaft according to some other embodiments of the present application.

FIG. 9 is a schematic diagram of the internal structure of the cover of a film-tearing device for a cooking machine according to some embodiments of the present application.

FIG. 10 is a schematic diagram of a rotation angle sensor assembly of a cooking machine according to some embodiments of the present application.

FIG. 11 is a structural schematic diagram of a cooking machine according to some embodiments of the present application.

FIG. 12 is a structural schematic diagram of an unwind mechanism of a cooking machine according to some embodiments of the present application.

FIG. 13 is a structural schematic diagram of a cover with its open state being open of a cooking machine according to some embodiments of the present application.

FIG. 14 is a schematic diagram of the internal structure of an unwind mechanism of a cooking machine according to some embodiments of the present application.

FIG. 15 is a partial cross-sectional structural diagram of an unwind mechanism of a cooking machine according to some embodiments of the present application.

FIG. 16 is a schematic diagram of a shaft of an unwind mechanism of a cooking machine according to some embodiments of the present application.

FIG. 17 is a flowchart of a method for unwinding a sealing film of a cooking machine according to some embodiments of the present application.

FIG. 18 is a schematic diagram of a cooking machine whose cover is detachably connected to a body according to some embodiments of the present application.

### DESCRIPTION OF EMBODIMENTS

Those skilled in the art should understand that the embodiments and the implementations are merely used to explain the technical principles of the technical solutions of the present application and are not intended to limit the scope of protection of the technical solutions of the present application. Those skilled in the art may adjust them as needed to suit specific application scenarios.

In the description of the embodiments of the present application, it should be noted that, unless otherwise specified or limited, the terms "connected" and "connection" should be understood in a broad sense. For example, they can refer to fixed connections, detachable connections, movable connections, or integral connections; they can refer to mechanical connections or electrical connections; they can refer to direct connections or indirect connections through an intermediate medium. Those skilled in the art will understand the specific meanings of the above terms in the embodiments of the present application based on the specific circumstances.

In the embodiments of the present application, unless otherwise expressly specified or limited, a first feature being "above" or "below" a second feature may mean that the first and second features can be in direct contact, or that the first and second features can be in indirect contact through an intermediate medium. Furthermore, a first feature being "above", "on" and "over" a second feature may mean that the first feature is directly above or obliquely above the second feature, or may simply mean that the first feature is higher in level than the second feature. A first feature being "below", "beneath" and "under" a second feature may mean that the first feature is directly below or obliquely below the second feature, or may simply mean that the first feature is lower in level than the second feature.

As used herein, singular references (e.g., "a", "an", "first", "second", etc.) do not exclude a plurality. The term "a" or "an" object, as used herein, refers to one or more of that object. The terms "a" (or "an"), "one or more", and "at least one" are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

The present application will now be described in further detail with reference to the drawings and embodiments.

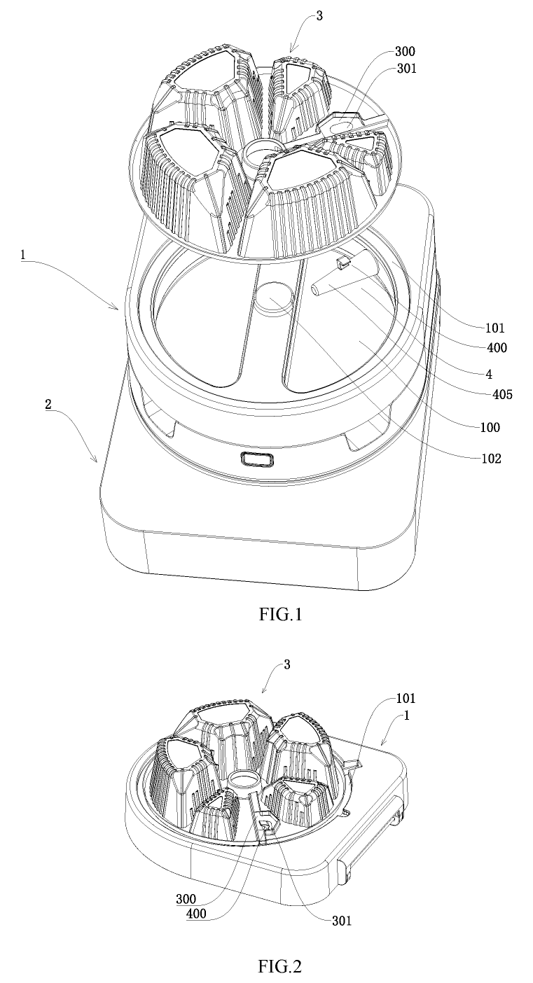

As shown in FIGS. 1-6, this application discloses a cooking machine, which includes a body 2 capable of heating cooking materials and a film-tearing device. The body 2 includes a base and a heating device. The heating device is disposed inside the base, and a pot-containing space is formed above the heating device in the body 2. Specifically, the heating device can be an electric heating device, such as an electromagnetic heating device, a microwave heating device, or a heating plate with heating elements such as heating wires. The top of the body 2 is provided with a top opening communicating with the pot-containing space. The film-tearing device is disposed on the top of the body 2 and corresponds to the top opening of the body. The film-tearing device is configured to support a food container 3 and tear a sealing film 300 of the food container 3, thereby allowing the cooking materials in the food container 3 to fall into a pot placed in the pot-containing space as expected.

The food containers 3 in the art used for storing cooking materials are round or square. The food container 3 is partitioned into discrete compartments, wherein each cavity is fluidly isolated to prevent cross-contamination of the cooking materials. The sealing film 300 is hermetically bonded to the food container 3 to encapsulate the materials within their respective cavities until they are selectively released or accessed. When cooking, the food container 3 is placed upside down on the film-tearing device, with the sealing film 300 facing the film-tearing device. After tearing the sealing film 300, the cooking materials fall into the body 2. To make cooking more similar to human cooking and achieve better taste, different materials are disposed sequentially according to the cooking order of the recipe. In addition, the sealing film 300 has an opening 301 for cooperating with the film-tearing device, which may be created by the user during use or pre-formed during the manufacture of the food container 3.

In some embodiments, the film-tearing device of the cooking machine includes a cover 1 mounted on the body 2, a shaft 4 for tearing the sealing film 300, and a motor 5 for rotating the shaft. The cover 1 is disposed on the body 2 and is configured to support the food container 3. The shaft 4 is disposed on the cover 1 and is configured to wind the sealing film 300 on the food container 3 so as to tear the sealing film 300 and drive the food container to rotate. Specifically, as shown in FIG. 1, the cover 1 is pivotally connected to one side of the top of the body 2. The cover 1 can be rotated to a closed position. At the closed position, the cover 1 can be laid flat on the body 2 and the food container 3 can be placed upside down on the cover 1, so that the food container 3 can be arranged directly above the top opening of the body 2. The cover 1 can also be rotated to an open position so that the top opening of the body 2 is not blocked by the cover 1, allowing operations such as transferring food from the pot and taking out the pot.

In some embodiments, the cover 1 has an opening 100 extending through its top and bottom. The cover is configured to support the food container with the sealing film facing downwards. The top of the cover 1 may form a supporting surface 101 for the food container 3 to be placed upside down. Specifically, the top of the cover 1 is provided with a downward recessed circular groove, the bottom plane of which forms the supporting surface 101, and the side of which can also guide the rotation of the circular food container 3. In addition, the supporting surface 101 and the guiding structure for the rotation of the food container 3 can be set to other structures. For example, the top of the cover 1 may also be provided with a ring-shaped protrusion to limit the position of the food container 3.

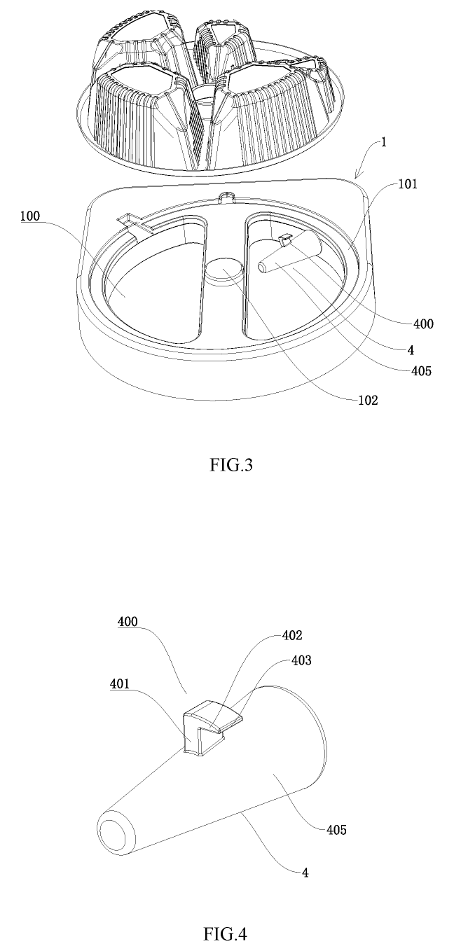

As shown in FIGS. 1 and 3, the shaft 4 is disposed inside the opening 100. The shaft 4 includes a shaft body and a hook 400. The motor 5 is connected to the cover 1, and the motor 5 is drivenly connected to the shaft 4 to drive the shaft 4 to rotate in order to wind and tear off the sealing film 300 on the food container 3 or to unwind the sealing film 300 wound on the shaft 4. The film-tearing device of the present application is suitable for a round food container 3. When the shaft 4 is winding and tearing off the sealing film 300, it drives the food container 3 to rotate around its central axis. In order to make the food container 3 rotate smoothly and make the sealing film 300 wind more evenly, a circular protrusion 102 is provided at the center of the cover 1. The center of the round food container 3 is provided with an inner recess or through hole that matches the circular protrusion 102. When the food container 3 is upside down on the supporting surface 101 of the cover 1, the inner recess of the food container 3 is fitted onto the circular protrusion 102 at the center of the cover 1. During the process of the shaft 4 winding and tearing the sealing film, the food container 3 rotates around the axis of the circular protrusion 102. In addition, the protruding and recess portions may be interchangeable.

As shown in FIGS. 3 and 5, to ensure smoother rotation of the food container 3 during the film-tearing process, the shaft 4 may be a tapered shape with a smaller outer end and a larger inner end, where the outer end is the end closer to the center of the cover. For the round food container, considering the difference in diameter between the inner and outer rings of the food container, the shaft 4 is designed as a tapered shape to reduce uneven force during the film-tearing process. Furthermore, the axis of the shaft 4 intersects with the central axis of the food container 3. Therefore, the projection of the axis of the shaft 4 onto the sealing film 300 of the round food container 3 falls in the radial direction of the sealing film 300.

In some embodiments, as shown in FIGS. 3 and 4, the shaft 4 includes a shaft body 405 and a hook 400. The hook 400 is disposed on the shaft body 405. To facilitate the film-tearing process and make the tearing operation simpler, more convenient, and safer, the hook 400 on the shaft body of the shaft 4 is radially outward of a circumference of the shaft body 405. When the hook 400 faces the top of the cover 1 and the food container 3 is placed upside down on the supporting surface 101, the hook 400 can extend into the opening 301 on the sealing film 300 of the food container 3. The hook 400 protrudes relative to the outer circumferential surface of the shaft body 405. When the shaft 4 is in its initial position, the hook 400 on the shaft 4 faces the sealing film 300 of the food container 3. The initial position of the shaft 4 can be referred to as the angle at which the shaft 4 is positioned before each film-tearing process of the cooking machine, or the angle at which the shaft 4 is positioned after each film-unwinding process of the cooking machine.

When performing the film-tearing process, the user simply needs to place the food container 3 upside down on the supporting surface 101 of the cover 1, and then rotate the food container 3 to match the hook 400 with the opening 301 on the sealing film 300 of the food container 3. The hook will extend into the food container 3 through the opening 301. There is no need to press the sealing film 300 by hand to hook the edge of the opening 301 on the sealing film 300 onto the hook 400. Therefore, the operation is simple and convenient, and it can reduce burn risk caused by the user touching the shaft 4, which is safe. Furthermore, the hook 400 is designed to protrude from the surface of the shaft body 405 of the shaft 4, so that the space between the hook 400 and the shaft body 405 is larger. This not only facilitates cleaning, but also allows the wound sealing film 300 to adhere more loosely to the shaft body 405 when the sealing film 300 is being unwound and torn off, thereby inhibiting the sealing film 300 from sticking to the shaft body 405 when removing the sealing film.

Further, in some embodiments, as shown in FIGS. 3, 4, and 6, the hook 400 of the shaft 4 includes a shank 401 and a transverse portion 402. The shank 401 extends and protrudes radially relative to the shaft body 405. The transverse portion 402 is located at the free end of the shank 401, extending relative to the shank 401 along the circumferential direction of the shaft body 4. The shape of the transverse portion 402 can be any shape suitable for hooking the sealing film. For example, it can be straight, curved, angled, hook-shaped, or arc-shaped, to securely hook the sealing film. That is, one end of the shank 401 is connected to the shaft body 405 and protrudes and extends radially outward relative to the shaft body 4. The transverse portion 402 is connected to the other end of the shank 401 and is integrally formed with the shank 401, extending circumferentially along the shaft 4. Furthermore, the lower surface of the transverse portion 402 is radially outward of the circumferential surface of the shaft body 405. It is understood that the supporting surface 101 on the cover 1 is a plane that is horizontally attached to the sealing film 300 of the food container 3 when the food container 3 is placed upside down. When the food container 3 is placed upside down, the hook 400 extends into the opening on the sealing film 300, and the lower surface of the transverse portion 402 is higher than the edge(s) of the opening 301. Specifically, the height difference between the lower surface of the transverse portion 402 and the supporting surface 101 can be greater than 1 mm. The free end of the transverse portion 402 forms a hook edge 403, which is higher than the supporting surface 101. The distance between the hook edge 403 and the supporting surface 101 may be greater than 1 mm. Therefore, when the food container 3 is placed upside down on the supporting surface 101, the transverse portion 402 of the hook 400 extends into the food container through the opening 301 of the sealing film. When the food container 3 is rotated, one side of the opening 301 can be engaged into the transverse portion 402 of the hook 400. In this way, there is no need to manually press the sealing film 300. Just rotate the food container 3 placed upside down on the supporting surface 101 at a small angle so that the edge(s) of the opening 301 on the sealing film 300 is engaged into the transverse portion 402 of the hook 400. The sealing film 300 can be wound and torn off by the rotation of the shaft 4.

It is easy to understand that, the free end of the shank 401 refers to the end of the shank 401 that is relatively far away from the shaft body 405, and the free end of the transverse portion 402 refers to the end that is relatively far away from the shank 401.

Furthermore, the angle between the shank 401 and the lower surface of the transverse portion 402 may be less than or equal to 90 degrees. When the food container 3 is placed upside down on the supporting surface 101, the heat inside the body 2 will cause the sealing film 300 of the food container 3 to deform due to heat. By setting the angle between the transverse portion 402 and the shank 401 to less than or equal to 90 degrees, the shaft 4 can inhibit the hook 400 from detaching from the sealing film 300 when winding the sealing film 300, or inhibit the transverse portion 402 of the hook 400 from failing to firmly hook the sealing film 300, thereby making the film-tearing process faster.

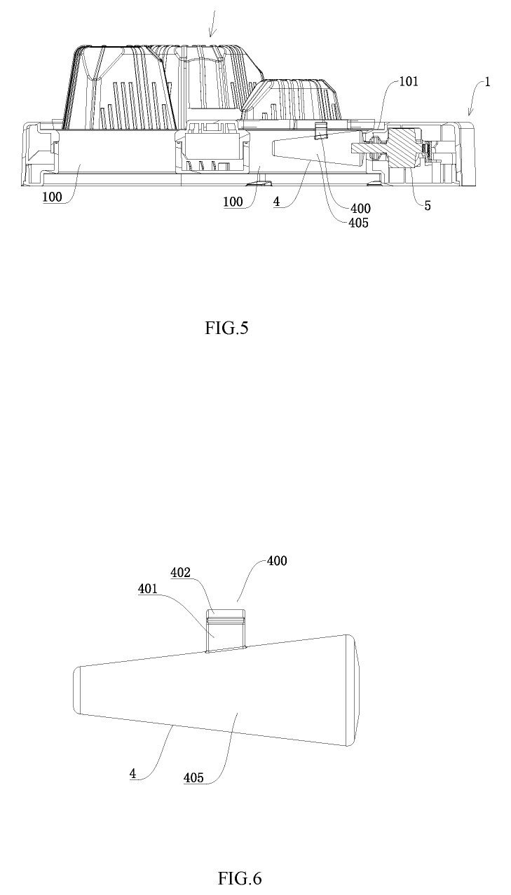

In some embodiments, as shown in FIGS. 4 and 6, the top surface of the transverse portion 402 is set as a smoothly transitioned arc surface, which makes the top surface of the transverse portion 402 of the hook 400 more rounded. This arrangement not only reduces the scratching risk for the user's fingers and makes the cooking machine highly safe, but also reduces the scratching possibility for the sealing film 300 of the food container 3 during the process of winding and hooking with the hook 400.

Furthermore, in some embodiments, as shown in FIGS. 5 and 6, the shaft body is tapered in shape, and the axis of the shaft body 4 is set horizontally. This allows the shaft 4 to be installed horizontally, which not only facilitates the installation of the shaft 4, but also makes the installation and assembly of the motor 5 and its related elements more convenient.

The hook 400 is radially outward, and the surface of the shaft body 405 and the supporting surface 101 are not parallel arranged. These arrangements allow for a gap between the surface of the shaft body 405 and the sealing film 300 of the food container 3 on the supporting surface 101, thus inhibiting at least a part of the surface of the shaft body 405 from tightly adhering to the sealing film 300. It is understood that the sealing film 300 of the food container 3 may adhere to the surface of the shaft 4 under the high temperature and pressure within the body 2. The cooking machine of the present application reduces the adhesion risk by the above settings. More specifically, by horizontally installing the shaft 4 in conjunction with the tapered design of the shaft body 405, the gap is maintained between the surface of the shaft body 405 and the sealing film 300 of the food container 3, effectively reducing adhesion risk for the sealing film 300 and the surface of the shaft 4.

In some embodiments, the hook 400 is non-detachably connected to the shaft body 405. Specifically, the hook 400 is fixedly connected to the surface of the shaft body 405 by welding or integral molding. This facilitates cleaning of the hook 400 and the surface of the shaft 4 that is close to the hook 400.

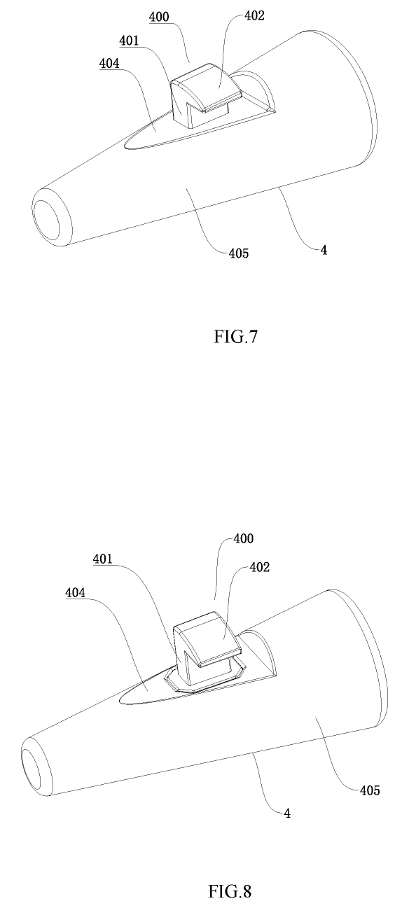

In some embodiments, the hook 400 connected to the shaft body 405 may also be implemented as follows. As shown in FIG. 7, the shaft 4 is cut off to form a mounting plane 404 on it, and the hook 400 is mounted on the mounting plane 404. For the hook 400 mounted on the mounting plane 404, the lower surface of the transverse portion being radially outward relative to the circumference of the shaft body means that the lower surface of the hook is radially outward relative to at least beyond the cutting edges on the circumference of the shaft body. The mounting plane 404 is parallel to the axis of the shaft body 4, and the hook 400 may be fixedly connected to the mounting plane 404. This makes it easier to connect the hook 400 to the shaft body 405. Specifically, it facilitates the positioning and welding of the hook 400 when welding it to the shaft body 405.

In some embodiments, the hook 400 may be configured as a movable hook 400. Specifically, the hook 400 can move in the radial direction relative to the shaft body 405. Specifically, the hook 400 is connected to the shaft body 4 and can slide in the radial direction of the shaft body 4. An elastic element is connected between the hook 400 and the shaft body 4 to make the hook 400 always have a tendency to move away from the shaft body 4.

For example, as shown in FIG. 8, the mounting plane 404 is formed by cutting off the shaft 4. The mounting plane 404 is parallel to the axis of the shaft 4, and a radial groove is recessed in the mounting plane 404 toward the axis of the shaft body. The shank 401 of the hook 400 is radially slidably connected in the radial groove, and the shank 401 does not detach from the radial groove. An elastic element is provided between the radial groove and the shank 401 of the hook 400. The elastic element may be a compression spring or a spring sheet. Under the action of the elastic force, the transverse portion 402 of the hook 400 always has a tendency to move away from the tearing shaft body 405. Therefore, the hook 400 is always in the extended state. It is easy to understand that, because the lower surface of the transverse portion 402 of the hook 400 can be higher than the supporting surface 101, when the sealing film is being torn off, the elastic hook 400, due to the tension of the sealing film, retracts and lowers as the transverse portion 402 hooks the sealing film 300 and winds it, making the food container 3 more stable during rotation. Furthermore, the mounting plane 404 also provides space for the hook 400 to retract in the radial groove direction.

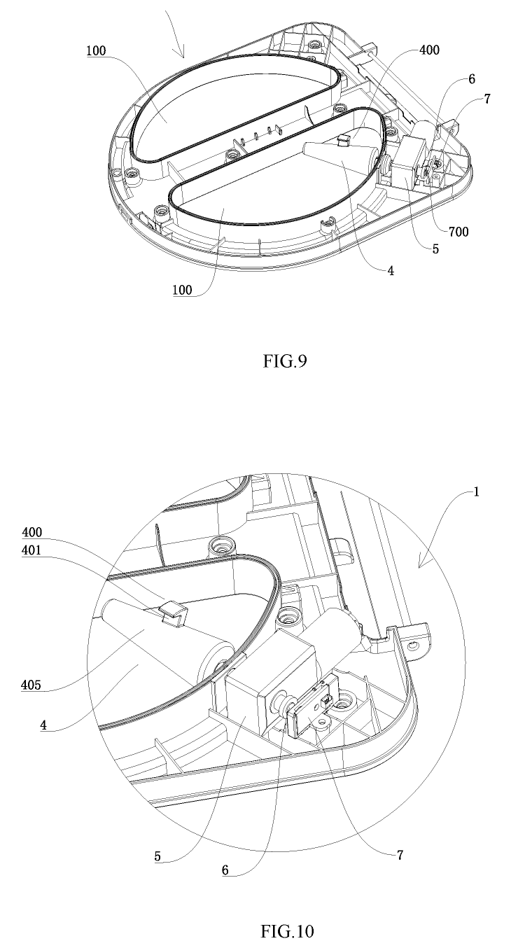

Before tearing off the sealing film, the shaft 4 may be at a rotation angle that makes the hook 400 not face the sealing film 300. Therefore, manual adjustment is required to rotate the shaft 4 and position the hook 400 towards the sealing film 300, facilitating its insertion into the opening of the sealing film 300 and hooking it. To this end, in some embodiments, as shown in FIG. 9, the film-tearing device may further include a rotation angle sensor assembly arranged for detecting an angular position of the shaft 4, ensuring that the hook 400 faces the sealing film 300 of the food container 3 when the shaft 4 is in its initial position. The rotation angle sensor assembly detects the rotation angle of the hook by detecting the angular position of the shaft 4. According to the information detected by the rotation angle sensor assembly, the angular position of the shaft 4 can be rotated to the initial position where the hook 400 faces the sealing film 300 of the food container 3. Therefore, after each film-unwinding process or before each film-tearing process, the rotation angle sensor assembly helps to rotate the shaft 4 to its initial position with the hook 400 facing the sealing film 300 of the food container 3, facilitating its insertion into and hooking the sealing film 300 of the food container 3.

In addition, the rotation angle sensor assembly may detect and record the rotation stroke of the shaft in real time during the film-tearing process, so as to control the film-tearing process according to the cooking time required for each cooking material in the food container.

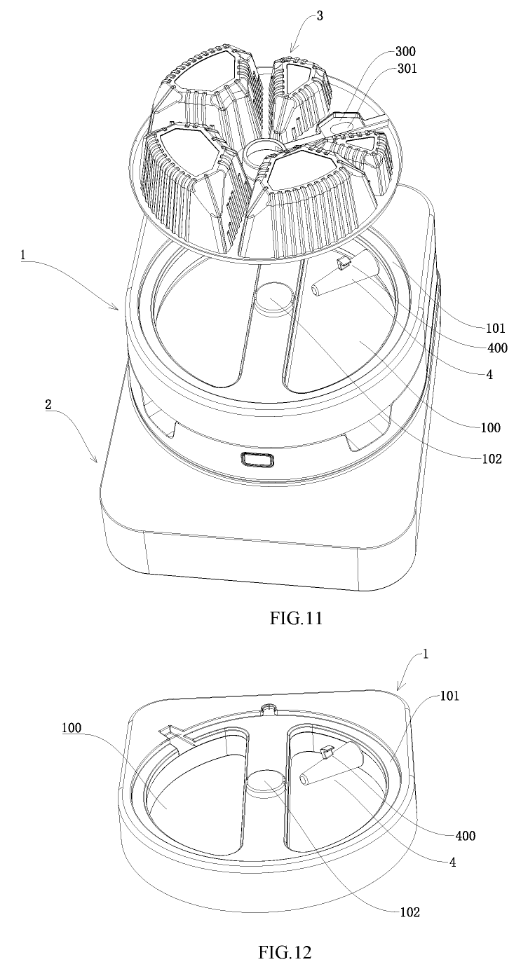

For example, as shown in FIGS. 9 and 10, the rotation angle sensor assembly includes a second magnet 6 driven by the shaft of the motor 5 and a sensor assembly 7 connected to the cover 1. The sensor assembly 7 has a magnetic induction chip 700 which detects the rotation angle of the hook 400 of the shaft 4 by sensing the change in the magnetic field of the second magnet 6. The second magnet 6 includes a pair of magnets sequentially arranged along a circumferential direction, and the magnetic poles of the two magnets are opposite to each other. It can be understood that the second magnet 6, which includes the pair of magnets with opposite arranged magnetic poles, forms a circular magnetic field along the clockwise or counterclockwise direction, and the strength of the magnetic field along the circumference is distributed from strong to weak and from weak to strong from the N pole to the S pole. The magnetic induction chip 700 can sense the strength of the magnetic field on the second magnet 6 and generate an electrical signal to be fed back to the control circuit of the sensor assembly 7, thereby detecting the rotation angle of the shaft 4 and improving the control accuracy of the rotation of the shaft 4. Specifically, the magnetic induction chip 700 may be a Hall effect sensing element integrated on the circuit board of the sensor assembly 7 for detecting magnetic field strength. In addition, the magnetic induction chip 700 may also be a magneto-resistive sensor or the like.

In some embodiments, the second magnet 6 may be magnetic elements arranged in other ways, such as including two pairs of magnets distributed sequentially along the circumference, with the two magnets of each pair having opposite arranged magnetic poles. The magnetic elements can also be directly mounted on the shaft 4, and the sensor assembly 7 detects changes in the strength of the magnetic field to calculate the orientation of the hook 400.

As shown in FIGS. 9 and 10, the rotation angle sensor assembly can be located on the side of the motor 5 away from the opening 100.

In some embodiments, the rotation angle sensor assembly may also be located on the side of the motor 5 facing the opening 100. Specifically, a first gear is coaxially mounted on the shaft 4, and the first gear rotates as the shaft 4 rotates. A second gear meshing with the first gear is mounted on the cover 1, and the second magnet 6 is mounted on the second gear. The sensor assembly 7 opposite to the second magnet 6 is mounted on the cover 1. When the shaft 4 rotates, the second gear is driven to rotate by the first gear, and the second magnet 6 rotates synchronously with the second gear. The sensor assembly 7 detects the change in magnetic field information and determines the hook rotation angle of the shaft 4.

Based on any one of the above-mentioned cooking machines with a rotation angle sensor assembly, this application also discloses a control method for the cooking machine. The control method includes:

detecting a rotation angle of a hook by a rotation angle sensor assembly;

generating, according to the rotation angle of the hook, adjustment information by a rotation angle sensor assembly;

rotating, according to the adjustment information, a shaft by a motor so as to adjust the hook to face a top of the cover; and

rotating, in response to a start signal, the shaft by the motor to wind and tear off a sealing film of a food container.

The above control method uses the rotation angle sensor assembly to detect the rotation angle of the hook of the shaft, so that the shaft 4 can be adjusted to its initial position. Therefore, the hook 400 can face the sealing film 300 of the food container 3, making it convenient for the hook 400 to extend into and hook the sealing film 300 of the food container 3. The initial position of the shaft 4 can be the angle at which the shaft 4 is before each film-tearing process of the cooking machine, or the angle at which the shaft 4 is after each film-unwinding process. Therefore, the angle adjustment steps in the above control method can be executed after each film-unwinding or before each film-tearing process. The start signal can be triggered by a button operation or the like from the user.

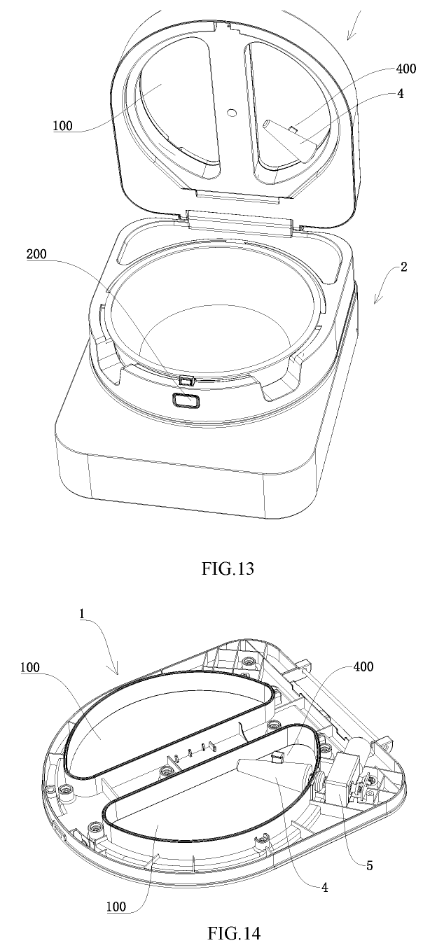

In some embodiments, as shown in FIGS. 11-16, a control module may be provided inside the body 2. This control module includes a control circuit board connected to the body, a control panel, and a display panel mounted on the body 2. This control module is the intelligent control part of the cooking machine and can be used to control the cooking processes, display the cooking progress, set the cooking time and so on. The cover 1 can rotate relative to the body 2 between a closed position and an open position. The shaft is mounted on the cover 1 and moves with the cover. Therefore, the cover 1 has an open state. Specifically, when the cover is in the closed position, its open state is closed; when the cover is in the open position, its open state is open. As shown in FIGS. 11 and 13, the cover 1 is pivotally connected to one side of the top of the body 2. When the cover 1 rotates to the closed position, it lies onto the body 2. At this position, placing the food container 3 upside down on the cover 1 will match the food container 3 directly above the opening at the top of the body 2. When the cover 1 rotates to the open position, the opening at the top of the body 2 is not blocked by the cover 1, allowing for operations such as transferring food from the pot, taking out the pot and removing the sealing film.

In some embodiments, a cover opening button 200 may be provided on the body 2. When the cover opening button 200 is pressed, the cover 1 will open under the action of elasticity.

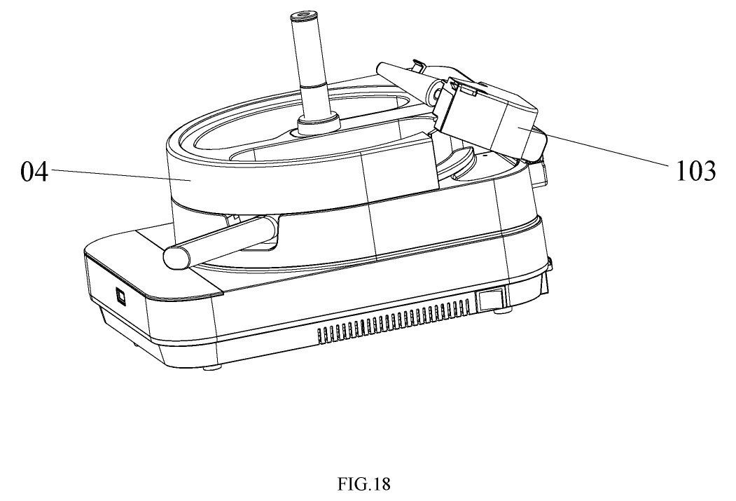

In some embodiments, the cover 1 can also be detachably connected to the body 2 so that the user can clean the cover 1. As shown in FIG. 18, the cover 1 includes a mounting base 103 and a main cover 104. An opening adapted to the mounting base 103 is provided on the main cover 104. The main cover 104 is detachably connected to the body 2. The mounting base 103 is pivotally connected to the body 2. The shaft 4 is mounted on the mounting base 103.

The cooking machine is suitable for a round food container 3. The food container 3 contains the cooking materials, and its opening is sealed with the sealing film 300. When cooking manually, different cooking materials are added sequentially according to the recipe. To make the cooking effect of the cooking machine closer to manual cooking and achieve a better taste, the food container 3 stores different cooking materials in the order specified in the recipe.

The cooking machine is configured to sequentially dispense cooking materials from a food container into the body for cooking in accordance with a preset cooking program during a cooking process. Specifically, as shown in FIGS. 11, 12, 13, and 14, the cover 1 has the opening 100 extending through its top and bottom, and the top of the cover 1 has a supporting surface 101 for the food container 3 to be placed upside down. Specifically, the top of the cover 1 has the downward recessed circular groove, the bottom plane of which forms the supporting surface 101, and the side of the circular groove can also guide the rotation of the food container 3. In addition, the supporting surface 101 and the guiding structure for the rotation of the food container 3 can be set to other structures. For example, the top of the cover 1 can also be provided with a ring-shaped protrusion to limit the position of the food container. Furthermore, the shaft 4 is provided inside the opening 100, and a motor 5 electrically connected to the control module is connected to the cover 1 of the cooking machine. The motor 5 is connected to the shaft 4 for driving the shaft 4 to rotate to wind and tear off the sealing film 300 of the food container 3 that is upside down on the cover 1, or to drive the shaft 4 to unwind and remove the sealing film wound on the shaft 4. Therefore, during the cooking process, the food container 3 is placed upside down on the supporting surface 101 of the cover 1, and the sealing film 300 of the food container 3 is hooked with the shaft 4. During the cooking process, the control module controls the motor 5 to drive the shaft 4 to rotate, so as to wind and tear off the sealing film 300 of the food container 3 upside down on the cover 1 in sequence, so that the cooking materials in the food container 3 fall into the body 2 through the opening 100 for cooking. When the cooking process is finished, the cover opening button 200 is pressed to open the cover 1, and then the motor 5 drives the shaft 4 to unwind and remove the sealing film wound on the shaft 4.

When the shaft 4 winds and tears off the sealing film 300, it will drive the food container 3 to rotate around its central axis. In order to make the food container 3 rotate smoothly and make the sealing film 300 wind more evenly, a circular protrusion 102 is provided at the center of the cover 1. The center of the circular food container 3 is provided with the inner recess or through hole that matches the circular protrusion 102. When the food container 3 is upside down on the supporting surface 101 of the cover 1, the inner recess or through hole at the center of the food container 3 is fitted onto the circular protrusion 102 at the center of the cover 1. Therefore, during the process of the shaft 4 winding and tearing the film, the food container 3 rotates around the axis of the circular protrusion 102. In addition, the protruding and recess portions may be interchangeable.

To prevent accidental activation of the film-unwinding process without opening the cover 1, which may result in the sealing film falling into the cooked food, the cooking machine may further include an open state sensor assembly. The open state sensor assembly is connected to the cooking machine and is configured to detect a position of the cover, identify an open state of the cover, and send an first signal. Furthermore, the open state sensor assembly is electrically connected to the cooking machine's control module, which is arranged for detecting the first signal. Upon detecting the first signal, the control module controls the shaft to rotate to unwind the sealing film. Therefore, after the cooking machine finishes cooking, when the control module detects the first signal from the open state sensor assembly, it controls the motor 5 to rotate the shaft 4 to unwind the sealing film wound on the shaft 4. After the cooking machine finishes cooking, the control module automatically controls shaft 4 to unwind and remove the sealing film when it detects the first signal. Therefore, there is no need to manually press a button to start the film-unwinding process, simplifying and facilitating the film-unwinding process and automatically initiating the process at an appropriate timing. In addition, the control module automatically controls the shaft to rotate and unwind the sealing film when it detects the first signal, which can avoid accidental initiation of the film-unwinding process due to human error when the cover 1 is not opened, and effectively inhibit the sealing film from falling into the cooked food.

After the cooking machine finishes cooking, the manual pressing of the cover opening button 200 opens the cover 1, and then the cover 1 is rotated to the open position. The entire cover opening process needs to last for a certain period of time. Therefore, when the control module detects the first signal of the open state sensor assembly, it can delay the control of the film tearing motor 5 to drive the shaft 4 to rotate and unwind the sealing film. This delay control of the motor 5 can be set for a predetermined time, such as 3 to 10 seconds. After the predetermined time is completed, the motor 5 is automatically controlled to rotate and unwind the sealing film to avoid the film-unwinding process being completed before the cover 1 is fully opened, causing the sealing film to fall into the body 2.

In some embodiments, the open state sensor assembly can be a mechanical contact type. For example, it may include a trigger and a sensor. One of the trigger and the sensor is connected to the cover of the cooking machine, and the other one is connected to the body of the cooking machine. When the cover is opened, the distance between the trigger and the sensor changes. Specifically, the trigger may move closer to or further away from the sensor, causing the sensor to generate the first signal. Specifically, in some embodiments, as shown in FIG. 13, the open state sensor assembly includes a magnetic reed switch and a magnet adapted to the magnetic reed switch. The magnetic reed switch, also known as a magnetic reed tube, is the sensor and is electrically connected to the control module. The magnet is a permanent magnet and is the trigger. When the magnet approaches the magnetic reed tube, the generated magnetic field magnetizes the two reeds inside the magnetic reed tube, causing them to attract each other magnetically, thus completing a circuit. The open state sensor assembly determines that the cover is at its closed position. When the magnet moves away from the magnetic reed tube, the two reeds inside the reed tube lose their magnetism and reset under their own elasticity, breaking the circuit. The open state sensor assembly then determines that the cover is at its open position and sends the first signal.

Furthermore, the magnetic reed switch is connected to the body 2 of the cooking machine, and the magnet is connected to the cover 1, or the magnetic reed switch is connected to the cover 1, and the magnet is connected to the body 2. The cover 1 and the body 2 are pivotally connected by a pivot, and the open state sensor assembly is located on the side away from the pivot of the cover 1. Specifically, the magnetic reed switch is connected to the cover opening button 200 of the cooking machine, and the magnet is connected to the cover 1 and corresponds to the position of the magnetic reed switch. When the cover 1 is at the open position and away from the body 2, a magnetic reed switch circuit is disconnected to generate the first signal. The open state sensor assembly that includes the magnetic reed switch and the magnet is low in cost, simple to install, and convenient. In addition, the magnetic field generated by the magnet affects the magnetization of the magnetic reed inside the magnetic reed switch, so that the magnetic reed switch can be turned on without generating the first signal within a certain distance range between the magnet and the magnetic reed switch. Therefore, the defect of starting the film-unwinding process when the cover opening button is pressed but the cover 1 has not yet been flipped open can be avoided.

In some embodiments, the open state sensor assembly may also be located on the side close to the pivot of the cover 1, meaning that it is located on the side away from the cover button 200. With such arrangements, when the cover is at the open position, the trigger approaches the sensor to generate the first signal.

In addition, mechanical contact type open state sensor assembly can also use micro switches. The opening and closing of the micro switch circuit is used to detect whether the cover is open or closed. For example, the micro switch is connected to the body. When the cover is at the closed position, the micro switch is triggered to make the circuit open. When the cover is at the open position, the micro switch is closed to make the circuit open, thereby generating the first signal.

Based on a mechanical contact type structure, the open state sensor assembly can achieve proximity detection without the need for complex signal processing or comparison circuits. Its simple structure, few components, and compact system configuration help reduce manufacturing costs and system complexity. Furthermore, this type of structure maintains the contact state without continuous power supply, resulting in low power consumption, making it suitable for energy-sensitive applications or those requiring high electrical isolation. In addition, because the output is a direct physical conduction state, the control logic is clear and can be directly connected to subsequent control circuits, improving the directness and stability of the cooking machine's response.

In some embodiments, the open state sensor assembly can be electronic, meaning it uses a sensor to detect whether the cover is open or closed. Examples include inductive, capacitive, or photoelectric sensors. This type of open state sensor assembly detects changes in physical quantities and outputs a proximity status signal after internal signal amplification, comparison, and shaping. These implementations do not include a mechanical contact structure, offering high durability and lifespan, and can adapt to environments with frequent operation or vibration. Simultaneously, the electronic structure allows for threshold judgment, delay filtering, or anti-interference processing as needed, thereby improving detection accuracy and environmental adaptability.

As shown in FIGS. 12, 13, 14, and 16, the shaft 4 is provided with the hook 400 protruding from its surface in the radial direction. This hook 400 can extend into the opening 301 on the sealing film 300 of the food container 3, thereby hooking with the sealing film 300. This not only facilitates tearing off the sealing film from the food container but also inhibits the removed sealing film from automatically falling into the food in the body 2 after the motor 5 has rotated the shaft 4 to unwind the sealing film. Furthermore, the hook 400 is designed to protrude from the surface of the shaft 4, resulting in a larger space between the surface of the hook 400 and the shaft 4. This not only facilitates cleaning but also allows for a looser fit between the wound sealing film 300 and the shaft 4 when the sealing film 300 is wound and torn off, inhibiting the sealing film 300 from sticking to the shaft 4 during film removal and facilitating the film-unwinding process.

As shown in FIGS. 13, 14 and 16, the hook 400 on the shaft 4 includes the shank 401 and the transverse portion 402. The shank 401 is connected to the shaft body 405 and protrudes or extends outward along the radial direction of the shaft body 405. The transverse portion 402 is located at the free end of the shank 401 and is integrated with the shank 401. The transverse portion 402 extends in the rotation direction of the shaft 4. Therefore, the transverse portion 402 extends in the direction of rotation of the shaft 4. When the film-unwinding process is completed, the sealing film can be easily removed from the hook 400.

Specifically, the angle between the shank 401 and the transverse portion 402 can be less than or equal to 90 degrees. This is because when the food container 3 is placed upside down on the supporting surface 101, the heat inside the body 2 will cause the sealing film of the food container 3 to deform or expand due to heat. Setting the angle between the transverse portion 402 and the shank 401 to less than or equal to 90 degrees inhibits the hook 400 from detaching from the sealing film 300 when the shaft 4 winds the sealing film, thus making the film-tearing process faster. Additionally, it also inhibits the removed sealing film from falling into the food inside the body 2 at the end of the film-unwinding process.

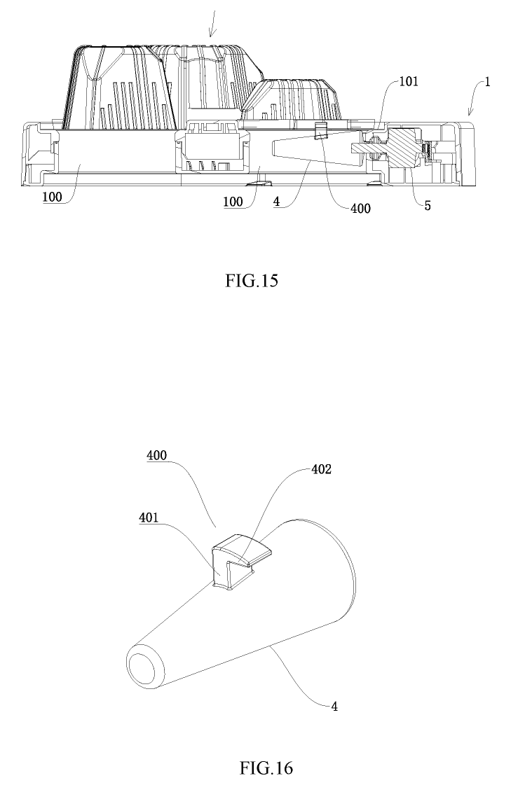

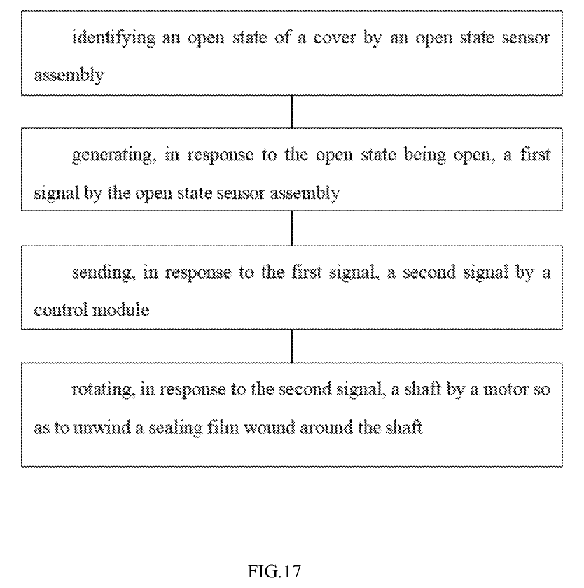

As shown in FIGS. 15 and 16, the shaft 4 is a tapered shaft with a smaller outer end and a larger inner end. The axis of the shaft 4 is parallel to the plane where the sealing film of the food container 3 is located. This allows the shaft 4 to be assembled horizontally during installation, which not only facilitates the installation of the shaft 4, but also makes the installation and assembly of the motor 5 and its components more convenient. Moreover, since the shaft 4 is tapered, there is a gap between the surface of the shaft 4 and the supporting surface 101. The existence of this gap allows a certain space to be reserved between the surface of the shaft 4 and the sealing film 300 of the food container 3 on the supporting surface 101, so that at least a part of the surface of the shaft 4 is not tightly attached to the sealing film 300. It is understood that the sealing film 300 of the food container 3 may adhere to the surface of the shaft 4 under the high temperature and pressure inside the body 2. These arrangements can reduce the risk of adhesion by setting the gap. More specifically, by using the horizontal installation of shaft 4 in conjunction with the tapered surface of shaft 4, a gap can be reserved between the surface of shaft 4 and the sealing film 300 of the food container 3, thereby effectively preventing the sealing film 300 from sticking to the surface of shaft 4 and facilitating the film-unwinding process.

As shown in FIGS. 1 and 7, this application further discloses a method for unwinding a sealing film of a cooking machine. The executing entity can be any one of the aforementioned cooking machines, which includes the open state sensor assembly and the control module. The method for unwinding the sealing film of the cooking machine includes the following steps.

identifying an open state of a cover by an open state sensor assembly;

generating, in response to the open state being open, a first signal by the open state sensor assembly;

sending, in response to the first signal, a second signal by a control module; and

rotating, in response to the second signal, a shaft by a motor so as to unwind a sealing film wound around the shaft.

After the cooking is finished, the user presses the cover opening button to open the cover, which will trigger the open state sensor assembly. The control module will only control the motor to rotate to unwind the sealing film when it detects the first signal from the open state sensor assembly. The method reduces the risk of the accidental activation of the film-unwinding process when the cover is not opened, effectively inhibiting the sealing film from falling into the cooked food. Furthermore, after cooking, there is no need to arrange any buttons for controlling the process manually, making the film-unwinding process simple and convenient.

For the cooking machine whose open state sensor assembly includes a magnet and a magnetic reed switch, the identifying, by an open state sensor assembly, an open state of a cover, includes:

controlling, according to a distance between a magnet and a magnetic reed switch, a conduction state of a circuit by the magnetic reed switch; and

determining, according to the conduction state of the circuit, the open state of the cover by the open state sensor assembly.

Specifically, when the magnet approaches the magnetic reed switch, the generated magnetic field magnetizes the two magnetic reeds inside the magnetic reed switch, causing them to attract each other magnetically, thus completing a circuit. The open state sensor assembly then determines that the cover is at the closed position and the open state of the cover is closed. When the magnet moves away from the magnetic reed switch, the two magnetic reeds inside the reed switch lose their magnetism and reset under their own elastic force, breaking the circuit. The open state sensor assembly determines that the cover is at the open position and the open state of the cover is open, and then sends the first signal.

Furthermore, for a cooking machine where the cover 1 is pivotally connected to the body 2, the opening angle of the cover 1 can be used to determine whether the cover is moving away from or closer to the body 2. For example, when the opening angle of the cover 1 is greater than a preset angle, the two magnetic reeds inside the magnetic reed switch lose their magnetism and reset under their own elastic force, indicating that the magnet is away from the magnetic reed switch and the open state of the cover is open. The preset angle can be 20 degrees, 30 degrees, 40 degrees, etc. Furthermore, for cooking machines where the cover 1 is pivotally connected to the body 2 or where the cover 1 is detachable, the distance between a specific position on the cover 1 and a specific position on the body 2 can also be used to determine whether the cover is moving away from or closer to the body 2. For example, when the distance between the magnetic reed switch and the magnet is greater than a preset distance, the two magnetic reeds inside the magnetic reed switch lose their magnetism and reset under their own elastic force, indicating that the magnet is away from the magnetic reed switch and the open state of the cover is open. The preset distance can be 0.4 times, 0.5 times, 0.6 times, etc., the diameter of the cover 1.

For the cooking machine whose open state sensor assembly is electronic-type, the identifying, by an open state sensor assembly, an open state of a cover, includes:

obtaining sensing information by a sensor; and

determining, according to the sensor information, the open state of the cover by the open state sensor assembly.

The sensor is connected to the cover or the body of the cooking machine.

When the cover approaches the body, the sensor of the open state sensor assembly detects the target component entering its sensing area, causing a change in the corresponding physical quantity and generating a detection signal. After internal amplification, comparison, and shaping, this detection signal outputs a proximity status signal when it reaches a preset threshold, and the open state sensor assembly determines that the cover is closed. When the cover moves away from the body, the target component leaves its sensing area, the physical quantity returns to its initial state, the detection signal amplitude decreases below the preset threshold, and after internal comparison and shaping, a non-proximity status signal is output. The open state sensor assembly determines that the cover is open and sends the first signal.

Specifically, for a cooking machine where the cover 1 is pivotally connected to the body 2, the opening and closing angle of the cover 1 can be used to determine whether the cover has entered or left the sensor's sensing area. For example, when the opening and closing angle of the cover 1 is greater than a preset angle, the target component leaves the effective detection range of the sensor, and the detection signal drops below a preset threshold, thus determining that the cover is at the open position. The preset angle can be 20 degrees, 30 degrees, 40 degrees, etc. Furthermore, for cooking machines where the cover 1 is pivotally connected to the body 2 or where the cover 1 is detachable, the distance between a specific position on the cover 1 and a specific position on the body 2 can also be used to determine whether the cover has entered or left the sensor's sensing area. For example, when the distance between the sensor and the target component is greater than a preset distance, the detection signal drops below a preset threshold, and after internal comparison processing, a non-proximity state signal is output, thus determining that the cover is at the open position. The preset distance can be 0.4 times, 0.5 times, 0.6 times, etc., the diameter of the cover 1.

It is understandable that during the process of the cover opening after pressing the cover opening button until it is fully opened, a certain amount of time may pass. Before the cover 1 is fully open, the film-unwinding process may have already ended, causing the sealing film to fall into the body 2. To avoid this situation, the process of the motor rotating to unwind the wound sealing film can be delayed before initiating the motor. Specifically, in the method, the sending, in response to the first signal, a second signal by a control module, includes: sending after a delay, in response to the first signal, a second signal by a control module. This delay can be preset and can be 3, 5, 7, or 10 seconds. After the control module receives the first signal, the motor rotates after the delay to ensure that the cover 1 is fully open before the motor is controlled to reverse, or the cover 1 is fully open before the film-unwinding process ends, inhibiting the sealing film from falling into the body 2.

Furthermore, during the cooking process of the cooking machine, the cover is on the body, and the open state sensor assembly does not generate the first signal. After the cooking machine finishes cooking, the cover is being opened, and the open state sensor assembly generates the first signal according to the open state of the cover. When the control module receives or detects the first signal generated by the open state sensor assembly, it initiates the motor or initiates the motor after a delay to start the film-unwinding process. However, if the cover is accidentally closed due to human error or the like before the film-unwinding process is completed, and the film-unwinding process continues, the unwound sealing film may fall into the body. Therefore, in the method, the in response to the second signal, a shaft by a motor so as to unwind a sealing film wound around the shaft, includes:

the motor starting to rotate the shaft;

in response to an absence of the first signal, the control module sending a third signal; and

in response to the third signal, the motor stopping rotating the shaft.

If the film-unwinding process is still in progress and the cover is accidentally closed, the open state sensor assembly will detect the cover which is not at its open position, so that the open state sensor assembly will not generate the first signal which can constantly exist as the cover is at the open position. In other words, the control module will not detect or will lose the first signal. At this point, the control module will stop the motor to halt the film-unwinding process. Therefore, this method further ensures the safety of the film-unwinding process.

In some embodiments, to further inhibit the sealing film from falling into the body before the cover is fully opened, the open state sensor assembly can generate the first signal after the cover is opened to a certain angle. For example, after the cooking is finished, if the cover opening button is pressed, the cover will automatically open to a certain angle under the action of the elastic force. If the angle between the cover and the body is 20 degrees at this time, the open state sensor assembly is not triggered at this angle and no first signal is generated. During the process of manually opening the cover, if the angle between the cover and the body is greater than 20 degrees or greater than 30 degrees, the open state sensor assembly is triggered and the first signal is generated.

In the description of the embodiments of the present application, it should be noted that in the description of the present application, terms such as "inside" and "outside" indicating directions or positional relationships are based on the directions or positional relationships shown in the accompanying drawings. This is only for the convenience of description and does not indicate or imply that the device or component must have a specific orientation, be constructed and operated in a specific orientation. Therefore, it cannot be understood as a limitation on the present application.

In the description of the present application, the description with reference to the terms "one embodiment", "some embodiments", "in one implementation", "for example", or "some implementations" means that the specific features, mechanisms, materials or characteristics described in conjunction with the embodiment or example are included in at least one embodiment or example of the present application. In this specification, the schematic representations of the above terms do not necessarily refer to the same embodiment or example. Moreover, the specific features, mechanisms, materials or characteristics described can be combined in a suitable manner in any one or more embodiments or examples. In addition, those skilled in the art can combine different embodiments or examples described in this specification and the features of different embodiments or examples, unless they are contradictory.

The above description is merely a specific embodiment of the present application, but the scope of protection of the present application is not limited thereto. Any changes or substitutions that can be easily conceived by a person skilled in the art within the technical scope disclosed in the present application should be included in the scope of protection of the present application. Therefore, the scope of protection of the present application should be based on the scope of protection of the claims.

What is claimed is:

1. A cooking machine, comprising:
a body, comprising a base and a heating device;
a cover mounted on the body, wherein the cover has an opening that extends through the cover, and the cover is configured to support a food container with a sealing film facing downwards; and
a shaft, comprising a shaft body and a hook, wherein the shaft is disposed inside the opening of the cover, and the hook is disposed on the shaft body; the hook comprises a shank and a transverse portion; the two ends of the shank are respectively connected to the shaft body and the transverse portion; a lower surface of the transverse portion is radially outward relative to a circumference of the shaft body, so that when the hook faces a top of the cover, the hook enters an interior of the food container through an opening on the sealing film of the food container and the lower surface of the transverse portion is higher than an edge of the opening of the sealing film.

2. The cooking machine according to claim 1, wherein an angle between the shank and the lower surface of the transverse portion is less than or equal to 90 degrees.

3. The cooking machine according to claim 1, wherein a top surface of the transverse portion is configured as a smoothly transitioned arc surface.

4. The cooking machine according to claim 1, wherein the shaft body is tapered in shape, and an axis of the shaft body is arranged horizontally.

5. The cooking machine according to claim 1, wherein the shaft body is provided with a mounting plane, and the hook is mounted on the mounting plane.

6. The cooking machine according to claim 1, wherein the shaft is integrally formed.

7. The cooking machine according to claim 1, wherein the hook is configured to move in a radial direction relative to the shaft body, and an elastic element is connected between the hook and the shaft body to make the hook have a tendency to move away from the shaft body.

8. The cooking machine according to claim 1, further comprising:
a motor connected to the shaft, wherein the motor is configured to drive the shaft to rotate, so that the shaft winds and tears off the sealing film on the food container or unwinds the sealing film wound on the shaft;
an open state sensor assembly, wherein the open state sensor assembly is configured to detect a position of the cover, identify an open state of the cover, and send a first signal;
a control module, wherein the control module is configured to detect the first signal and to control the shaft to rotate after the first signal is detected.

9. The cooking machine according to claim 8, wherein the open state sensor assembly comprises a trigger and a sensor; one of the trigger and the sensor is connected to the cover, and the other one of the trigger and the sensor is connected to the body of the cooking machine; the open state sensor assembly detects the position of the cover according to sensing information of the sensor, and when the trigger moves away from the sensor, the open state sensor assembly determines that the open state is open.

10. The cooking machine according to claim 9, wherein the sensor is a magnetic reed switch, the trigger is a magnet; when the magnet moves away from the magnetic reed switch, the magnetic reed switch switches between on and off states to generate the first signal.

11. The cooking machine according to claim 10, wherein the cover is pivotally connected to the body, and the magnetic reed switch and the magnet are both disposed at a side away from the pivot.

12. The cooking machine according to claim 1, further comprising a rotation angle sensor assembly arranged for detecting a rotation angle of the shaft.

13. The cooking machine according to claim 8, wherein the rotation angle sensor assembly comprises a second magnet connected to a motor shaft of the motor and a sensor assembly connected to the cover; the sensor assembly comprises a magnetic induction chip, the magnetic induction chip is configured to detect an angular position of the shaft by sensing a change of a magnetic field of the second magnet.

14. A method for unwinding a sealing film of a cooking machine, comprising:
identifying an open state of a cover by an open state sensor assembly;
generating, in response to the open state being open, a first signal by the open state sensor assembly;
sending, in response to the first signal, a second signal by a control module; and
rotating, in response to the second signal, a shaft by a motor so as to unwind a sealing film wound around the shaft.

15. The method according to claim 14, wherein the identifying, by an open state sensor assembly, an open state of a cover, comprises:
controlling, according to a distance between a magnet and a magnetic reed switch, a conduction state of a circuit by the magnetic reed switch;
determining, according to the conduction state of the circuit, the open state of the cover by the open state sensor assembly;
wherein one of the magnet and the magnetic reed switch is connected to the cover of the cooking machine, and the other one of the magnet and the magnetic reed switch is connected to a body of the cooking machine.

16. The method according to claim 14, wherein the identifying, by an open state sensor assembly, an open state of a cover, comprises:
obtaining sensing information by a sensor; and
determining, according to the sensor information, the open state of the cover by the open state sensor assembly;
wherein the sensor is connected to the cover or a body of the cooking machine.

17. The method according to claim 14, the sending, in response to the first signal, a second signal by a control module, comprises:
sending after a delay, in response to the first signal, a second signal by a control module.

18. The method according to claim 14, the rotating, in response to the second signal, a shaft by a motor so as to unwind a sealing film wound around the shaft, comprises:
the motor starting to rotate the shaft;
in response to an absence of the first signal, the control module sending a third signal;
in response to the third signal, the motor stopping rotating the shaft.

19. A control method for a cooking machine, comprising:
detecting a rotation angle of a hook by a rotation angle sensor assembly;
generating, according to the rotation angle of the hook, adjustment information by a rotation angle sensor assembly;
rotating, according to the adjustment information, a shaft by a motor so as to adjust the hook to face a top of the cover;
rotating, in response to a start signal, the shaft by the motor to wind and tear off a sealing film of a food container.
